(19) United States
(12) Patent Application Publication
(10) Pub. No.: US 2010/0143872 A1
(43) Pub. Date: Jun. 10, 2010

(54) DRIVER SAFETY PROGRAM BASED ON BEHAVIORAL PROFILING

(75) Inventor: Daniel P. Lankteee, Boonton Township, NJ (US)

Correspondence Address: ANATOLY S. WEISER, 3525 DEL MAR HEIGHTS ROAD, #295, SAN DIEGO, CA, 92130, US

(73) Assignee: Gold Cross Benefits Corporation, Boonton Township, NJ (US)

(21) Appl. No.: 12/705,960

(22) Filed: Feb. 15, 2010

Related U.S. Application Data
(63) Continuation-in-part of application No. 11/221,027, filed on Sep. 6, 2005, now Pat. No. 7,695,282.
(60) Provisional application No. 60/607,021, filed on Sep. 3, 2004.
(60) Provisional application No. 61/152,388, filed on Feb. 13, 2009.

(51) Int. Cl. G09B 9/04

(52) U.S. Cl. 434/65

(57) ABSTRACT

A computer system is configured to administer a psychological profiling test to a participant in a driver education program, or receive such profile from another source; to determine the participant's psychological profile. The system then selects a driver education program for the participant based on the profile. The system also selects a method of delivering the curriculum to the participant based on the profile. The system further selects a method of testing the participant's comprehension and retention of the curriculum material, also based on the profile. The system delivers the selected curriculum to the participant using the selected delivery method, verifies attendance or participation, and tests the participant's comprehension and retention of the curriculum material using the selected testing method.

### REFERENCE TO RELATED PATENT APPLICATION

The present application is a continuation-in-part and claims priority benefit of U.S. patent application Ser. No. 11/221,027, entitled DRIVER SAFETY PROGRAM, filed Sep. 6, 2005; which claims priority of provisional U.S. Patent Application Ser. No. 60/607,021, entitled MANAGERS DRIVER SAFETY OBSERVATION PROGRAM, filed on Sep. 3, 2004; the present application also claims priority of provisional U.S. Patent Application Ser. No. 61/152,388, entitled The Gold Cross Interactive Driver Behavioral Combined Assessment, Analysis and Training System, filed Feb. 13, 2009. Each Of the above-referenced patent applications is hereby incorporated by reference in its entirety as if fully set forth herein, including all figures, tables, and claims.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of driver safety and training programs. More particularly, the invention relates to customizable driver safety programs.

### BACKGROUND

For an employer, traffic accidents result in increased costs of conducting business. The costs of accidents include legal fees and settlements; workers' compensation, health, and vehicle insurance; and employees' time off work. Many of these costs, particularly costs of insurance, have being increasing at a rate faster than the rate of consumer price inflation. Yet driving often is an indispensable part of conducting business. This is particularly true for companies with representatives, salespersons, service personnel, and delivery personnel, who need to visit existing and potential customers on a regular basis. In order to reduce accident costs, many companies that need employees to drive regularly on company business implement driver safety and training programs.

Conventional driver safety programs typically employ preselected online training and “commentary drives” in which a manager (1) rides with an employee who drives one or more company vehicles (for example, cars, vans, or trucks), and (2) evaluates and critiques the employee's actions behind the wheel in a number of specific categories, such as vehicle spacing (tailgating), use of directional signals, seat belt use, observation of traffic control devices, and similar driving behavior. The manager instructs the employee-driver as to the proper methodologies for these categories during the commentary drive; the manager may also provide a written and/or verbal report to the employee-driver, to the company, or both. Conventional driver safety programs may also include presentation of an educational a curriculum, such as a video presentation, written presentation, and/or computer-generated presentation.

The conventional driver safety programs suffer from several drawbacks. First, most managers receive limited, if any, training in evaluating and correcting driving habits of employees. For example, the training may be limited to reading a short pamphlet or attending a course of rather limited scope. Such training may not properly prepare the manager to educate the employee regarding proper driving habits, techniques, and laws.

Second, the manager has other duties—e.g., sales performance management—which the manager probably considers to be his or her primary job responsibility. While such assessment of the relative importance of the various duties by the manager may be correct, it is likely to lead the manager to place insufficient emphasis on the driver training of the employees supervised by the manager.

Third, during the commentary drive the manager's attention may be diverted to a new problem before the manager fully addresses a previous problem. The manager may thus neglect to provide an adequate explanation of how to correct the previously-identified driver problem.

Fourth, the corrective effect of the commentary provided during the commentary drive may be both weak and short-lived, because both the employee-driver and the manager are preoccupied with other tasks and discussions during the drive. The attention of the employee-driver is necessarily divided between (1) actual driving, and (2) absorbing and responding to the comments provided by the manager. Similarly, the manager's attention may also be divided between (1) evaluating the actual driving of the employee-driver, (2) commenting on the observed problem driving behavior, and (3) taking written notes for a report. Such “multitasking” interferes with proper instructions by the manager, and with learning and retention of the learned material by the employee-driver.

Fifth, the manager may not be aware of information that, if it were known to the manager, would affect the manager's evaluation and the commentary provided to the employee-driver. For example, the manager may not be aware of the health status and typical driving patterns of the employee-driver, and of the mechanical state of the vehicle used during the commentary drive. For example, the manager may not be aware that the employee-driver requires corrective lenses for driving, or that the employee-driver takes medications that induce drowsiness. Because the employee-driver is likely to be on his or her best driving behavior during the commentary drive, the manager may also not become aware that the employee-driver has formed unsafe or otherwise undesirable driving habits, such as hard acceleration and braking, or excessive speed in turns. Similarly, the manager may not be aware that the employee does not schedule his or her daily appointments in a preferred sequence. (Generally, the first appointment of the day should be geographically farthest from home or office location of the employee-driver.)

Sixth, after evaluating the employee-driver and commenting on the drive, typically very little additional training takes place; and if additional training does take place, it is usually generalized training, not specifically targeted to correct the problem driving behavior that the manager noticed in the course of the commentary drive, or the problem driving behavior exhibited by the employee-driver at other times.

Seventh, the curriculum is generally uniform for all participants, regardless of person-to-person variations in attitude, ability, and other individual behavioral and psychological factors.

These shortcomings pose potential risk management and organizational liability problems, and may cause decreased employee performance.

### SUMMARY

A need thus exists for improved methods, systems, and articles of manufacture for individualized selection of driver education programs, individualized delivery of driver education programs, and individualized testing for comprehension and retention of driver education program materials.

Embodiments disclosed herein may address the above stated need by providing apparatus, methods, and articles of manufacture implementing a driver training program for improving driving skills and behaviors of participants. In accordance with an embodiment, a participant is subjected to psychological profiling. The results of the psychological profiling (i.e., the resulting psychological profile) are stored. A specific curriculum is then selected for the participant based at least in part on the psychological profile and possibly on certain additional information regarding the participant. In variants, the curriculum is optimized according to one or more of the specific psychological traits of the participant so that retention of the curriculum is improved and modification of the participant's driving behavior in accordance with the curriculum (for safer driving) becomes more probable. Similarly, a method for delivering the selected curriculum may be selected based at least in part on the psychological profile, to improve retention and behavioral modification. Further, testing of the participant's retention of the curriculum materials may also be selected based at least in part on the psychological profile.

In embodiments, a computer-implemented driver training program method for improving driving skills and behaviors of a participant includes obtaining by a computer a psychological profile of the participant. The method also includes analyzing by the computer the psychological profile of the participant to select from a plurality of driver education curricula a selected driver education curriculum for the participant. The method further includes delivering the selected driver education curriculum to the participant. The step of obtaining may include receiving by the computer the psychological profile of the participant, and/or administering by the computer to the participant a psychological profiling test to obtain the psychological profile of the participant.

The method may also include analyzing by the computer the psychological profile of the participant to select from a plurality of delivery methods a selected delivery method for delivery to the participant of the driver education curriculum, so that the step of delivering may be performed using the selected delivery method.

The method may also include analyzing by the computer the psychological profile of the participant to select from a plurality of testing methods a selected testing method for testing comprehension and retention by the participant of material of the selected curriculum, so that testing may he performed using the selected testing method.

The psychological profile may be a Dominance/Influence/Steadiness/Consciousness (DISC) profile, a COLORS profile, a Wilson Learning Systems profile, or a Myers-Briggs Type Indicator profile. Other profiling techniques are not excluded.

The delivery of the curriculum may be done directly to the participant at the computer system, or through a network.

The step of analyzing by the computer the psychological profile of the participant to select from the plurality of driver education curricula may include analyzing the psychological profile to select from a plurality of driver education topics one or more selected driver education topics, and, for each driver education topic from the one or more selected driver education topics, analyzing the psychological profile to select from a plurality of courses associated with each driver education topic a selected course.

The psychological profile may include a primary psychological trait. The step of analyzing by the computer the psychological profile of the participant to select from the plurality of driver education curricula may include analyzing the psychological profile to select from a plurality of driver education topics one or more selected driver education topics. Then, for each driver education topic from the one or more selected driver education topics, the step may include determining from a plurality of courses associated with each driver education topic a selected course. The selected course may correspond uniquely to the selected driver education topic and to the primary psychological trait.

In embodiments, the psychological profile is supplemented with additional information before the steps of analyzing.

In embodiments, the method also includes performing by the computer hazard recognition testing of the participant to obtain hazard recognition test results, and the selected curriculum is based on the hazard recognition test results.

In embodiments, the method also includes obtaining by the computer real-life driving data of the participant, and performing the step of administering the psychological profiling test so that the psychological profile is based in part on the real-life driving data of the participant.

In embodiments, a computer system includes a processor configured to cause the computer system to perform driver training program methods described above.

In embodiments, an article of manufacture includes a machine-readable memory storing instructions. When the instructions are executed by a processor of a computer system, the instructions configure the processor to cause the computer system to perform driver training program methods described above.

These and other features and aspects of the invention will be better understood with reference to the following description, drawings, and the appended claims.

### BRIEF DESCRIPTION OF THE FIGURES

FIG. 1 illustrates selected steps of a driver education method;

FIG. 2 illustrates selected aspects of a database containing a table listing driver education courses and corresponding primary psychological traits; and

FIG. 3 illustrates in a simplified block diagram manner a computer-based system configured in accordance with selected aspects of driver education methods described in this document.

### DETAILED DESCRIPTION

In this document, including the specification and appended claims, the words “embodiment” and “variant,” as well as similar expressions, refer to particular apparatus, process, or article of manufacture, and not necessarily to the same apparatus, process, or article of manufacture. Thus, “an embodiment,” “one embodiment,” “some embodiments” or a similar expression used in one place or context can refer to a particular apparatus, process, article of manufacture, or a plurality thereof; the same or a similar expression in a different place can refer to the same or a different apparatus, process, article of manufacture, or a plurality thereof. The expressions “alternative embodiment,” “alternatively,” and similar phrases are used to indicate one of a number of different possible embodiments. The number of possible embodiments is not necessarily limited to two or any other quantity.

The words “couple,” “connect,” “attach,” and similar expressions with their inflectional morphemes do not necessarily import an immediate or direct connection, but include connections through mediate elements within their meaning.

An “expert system” is a computing machine executing instructions of a computer program or set of programs that contain a body of knowledge about a particular domain, and a set of rules for the application of this knowledge to specific problems.

The word “company” and similar expressions refer to any kind of business entity or other organization, including municipal organizations and the general public, that uses a driving training program to improve driving skills and behaviors of persons associated with (e.g., working for) the organization, including sole proprietorships, general and limited partnerships, corporations, limited liability companies, limited liability partnerships, or any other kind of organization. It should be noted that the invention is not necessarily limited to embodiments administered for the benefit of a specific business entity.

“Driver improvement program,” “driver education program,” “driver training program,” “driver improvement program” and similar expressions refer to programs for enhancing driving skills and behaviors of persons.

The expression “employee-driver” and the word “participant” may be used interchangeably to refer to a person participating in a driver training program for the purpose of improving driver skills and behaviors of the person. It should be noted that the invention is not necessarily limited to embodiments used in the context of an employee-employer relationship.

“Actual driving information” and “actual driving pattern” refer to information regarding actual driving obtained through automated means during actual driving by a participant, for example, using a global positioning system and/or vehicle computer with various sensors installed in the participant's vehicle.

Other definitions may be found elsewhere in this document. The scope and spirit of the invention should not be construed as strictly limited to these definitions, or to the specific examples mentioned herein.

Reference will now be made in detail to one or more embodiments of the invention that are illustrated in the accompanying drawings. Same or similar reference numerals may be used in the drawings and the description to refer to the same apparatus elements and method steps. The drawings are in simplified form, not to scale, and omit apparatus elements and method steps that can be added to the described systems and methods, while including certain optional elements and steps.

Features of the present invention may be implemented in the Gold Cross Manager's Observation Program of the assignee of the invention. Some of these features may be described below, but the description may go beyond what is available in the program.

The program materials may include audio, video, computer graphics, and/or other presentation modes for driver training specific to a corporate or other driver safety policy. Various technological platforms may be used for delivery, including platforms capable of delivery over a network (the Internet, an intranet, an extranet or any other kind of public or private network) and various multimedia delivery methods, including iPod® delivery (and delivery through similar devices), iPad™ delivery (and delivery through similar devices), telephone and cell phone delivery (and delivery through similar devices), delivery through other telematic devices, CD/DVD presentations, and presentations stored on other memory devices, for example, presentations stored in magnetic disk drives and flash memories. The presentations may be delivered using a single delivery method (e.g., delivery of all materials over the Internet) or using a combination of different delivery methods (e.g., delivery of materials over the Internet and from a local CD/DVD drive). The presentations may be delivered over wired connections, wireless connections, or combinations of wired and wireless connections. The participant's psychological profile may affect the choice of curriculum materials, choice of the presentation method, and/or the choice and content of the testing offered to the participant.

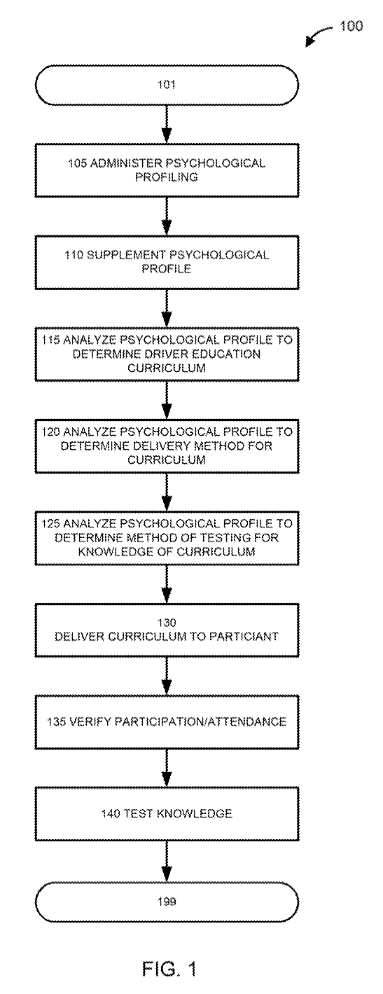

FIG. 1 illustrates selected steps of a method for selecting a curriculum for a participant, selecting a delivery method for the participant's curriculum and delivering the curriculum to the participant, and selecting and performing testing of the participant subsequent to the delivery of at least some portion of the curriculum. At flow point 101, a computer system is configured and ready to perform the following steps.

In step 105, the system administers a psychological profiling session to the participant. For example, the system presents to the participant questions and receives corresponding answers from the participant. It should be noted that here and elsewhere in this document, the verb “present” and its various inflectional morphemes signify exhibiting in any way, including directly on a display of the computer systems that performs the method steps, and over a network such as the Internet. The answers may also be received directly by the system or over the network. Presentation may be interactive.

The particular type of the psychological profiling may differ in various embodiments. As described in the commonly-owned U.S. patent application Ser. No. 11/221,027, the psychological profiling can be “DISC” (Dominance/Influence/Steadiness/Compliance) profiling. With DISC profiling, the primary psychological (behavioral) trait of the participant is identified as Dominance, Influence, Steadiness, or Compliance. One or more secondary psychological traits can also be identified. For example, the participant's psychological profile can be Dominance (primary); as another example, the participant's psychological profile can be (1) Dominance (primary) and (2) Steadiness (secondary). These are, of course, specific examples; any other psychological trait can be identified as a primary trait, and any one or more remaining traits can be identified as secondary traits. (There can also be no secondary trait identified, or a secondary trait can be ignored in subsequent processing.)

In the DISC framework, the Dominance trait indicates directness and decisiveness. Persons with Dominance as the primary trait are generally strong-willed, strong-minded people who like accepting challenges, taking action, and getting immediate results. They are extroverts, doers, agents of change, risk takers, fast-paced, task/result oriented; they tend to make quick decisions, “tell it like it is,” and want bottom line direct answers.

The Influence trait indicates optimistic and outgoing personality. Persons with Influence as the primary trait are generally “people people” who like participating on teams, sharing ideas, and energizing and entertaining others. They are expressive, extroverted, enthusiastic, fast-paced, gregarious, optimistic. They tend to like attention and social recognition.

The Steadiness trait indicates sympathetic and cooperative, optimistic personality. Persons with Steadiness as the primary trait are generally good listeners, they like working behind the scenes, performing in consistent and predictable ways, being helpful. They are calm, patient, diplomatic. They tend to resist change.

The Consciousness (a k a Compliance) trait indicates cautious, analytical, introverted personality. Persons with this primary trait are generally sticklers for quality and like planning ahead, employing systematic approaches, and checking and re-checking for accuracy. They pay attention to detail, avoid risk taking, follow rules. They tend to be quality focused, accurate, precise.

Additional information regarding DISC can be obtained from various sources, including the 36-page NPL document filed on Aug. 16, 2009, in the commonly-owned U.S. patent application Ser. No. 11/221,027, which NPL document is hereby incorporated by reference in its entirety.

The DISC profiling is not the only kind of psychological profiling that can be administered in the step 105. Other exemplary psychological profiling techniques include COLORS, Wilson Learning Systems, and Myers-Briggs Type Indicator (MBTI).

The COLORS profiling technique identifies four personality types, for example, Red (or Orange), Blue, Green, and Yellow (or Gold). Each represents a different kind of personality. More information on this profiling method may be found, for example, at http://www.truecolorstest.com/index.htm.

The Wilson Learning System identifies these four personality types: Amiable, Analytical, Driver, and Expressive. More information on this profiling method may be found, for example, at http://wilsonlearning.com/capabilities/sem/social_styles/.

The MBTI system classifies people as having one of two possible traits in each of four categories: (1) Extroverted or Introverted, (2) Sensing or Intuitive, (3) Thinking or Feeling, and (4) Judging or Perceiving. More information on this profiling method may be found, for example, at http://myersbriggs.org/.

Other psychological/behavioral personality profiling techniques and combinations and modifications of different psychological/behavioral personality profiling techniques may be used as well.

Advantageously, the psychological profile may be based in part on real-life driving habits of the participant. For example, a vehicle computer connected to appropriate sensors (for example, acceleration/braking sensors, speed sensors, cornering “g-forces” sensors, proximity to other car sensors) may be installed in the vehicle of the participant, either alone or in combination with a global positioning system. The computer can then log acceleration, braking, absolute speed, cornering forces, and distance to the car in front data for subsequent use in determining the participant's psychological profile and/or selecting a driver education curriculum together with delivery and testing methods. Driving patterns of the employee-driver in the course of a normal day may then be revealed and analyzed as part of the total assessment of his or her psychological profile. For example, relatively (to other drivers in similar vehicles) high acceleration and braking forces in conjunction with relatively short following distance may confirm a Dominance trait when a distinction needs to be made between DISC Dominance and DISC Influence in a close case.

In step 110, after the psychological profile of the participant is determined, the profile may be supplemented by additional information regarding the participant. The additional information may include, for example, driving experience (years and or miles), geographic location, age, results of vision and/or hearing screening, disabilities, other medical information, language, driving record, type of vehicle operated, drug (prescription and/or recreational) use, and results of hazard recognition testing. Hazard recognition testing may include computerized audiovisual or visual presentation that requires the participant to recognize and identify driving hazards in dangerous conditions, and show avoidance techniques. For example, the computer system may present on a screen a driver's view from a moving vehicle, and ask the participant to identify potential hazards such as pedestrians/children walking off the curb, getting out of a car, and to click on the recognized hazards. The participant can be scored on recognition of the hazards (recognized or not recognized, percentage of recognized hazards) and the time that it takes the participant to recognize each hazard.

The additional information may also include the observation drive information, real-life driving and other information described (in the context of determining a driver training program curriculum for the participant) in the commonly-owned U.S. patent application Ser. No. 11/221,027.

In step 115, the psychological profile (supplemented with the additional information, if applicable) is processed or analyzed by the system to determine an appropriate driver education curriculum, that is, an appropriate selection of driver training course(s). This is done at least in part by finding a best match to the psychological profile in a database of behavioral traits. The database may contain a list of driver education courses, each course characterized by weights applicable to the different traits. For example, a course can have four weights, one per DISC trait. A total “value” of the course for the participant can be determined by adding the weight corresponding to the primary psychological trait of the participant to a product of the weight corresponding to the secondary psychological trait of the participant times some discount factor such as 0.5. Note that a separate set of weights can be used for the secondary trait, thus avoiding the need for the use of the discount factor and providing more flexibility through independent assignment of the weights. For example, the set of primary weights can be 4, 2, 0, 0 (for the DISC traits), while the secondary weights can be 0.8, 0.6, 0.3, 0.1 (for the same DISC traits in the same order). The course with the highest computed value is then chosen for the participant, based on both the primary and the secondary trait.

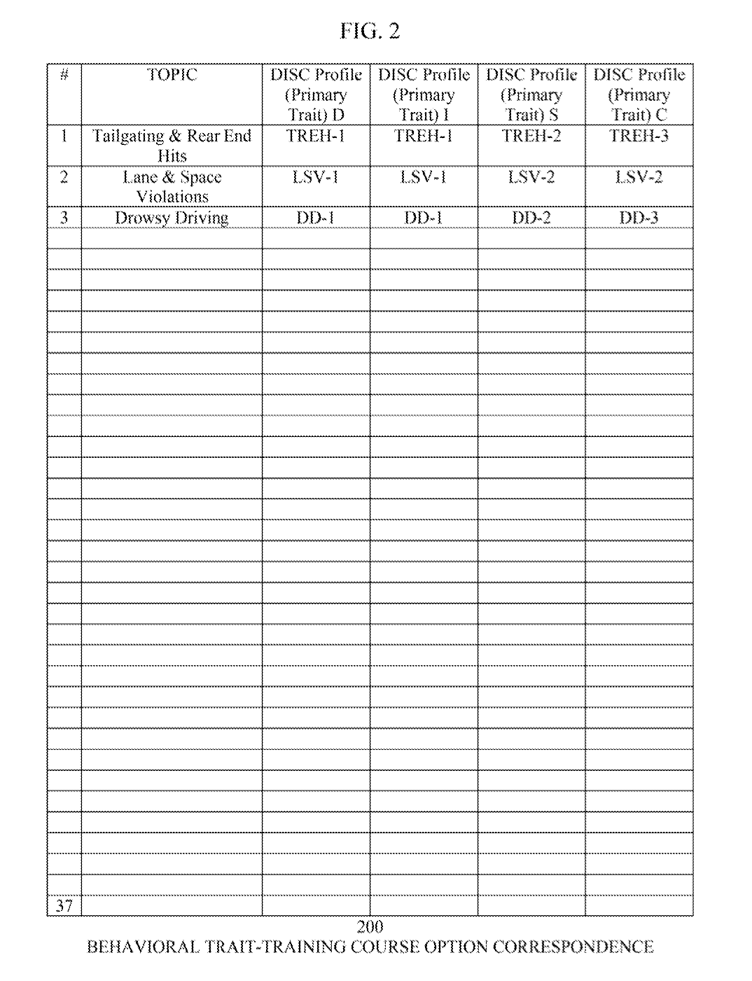

Alternatively or additionally, the database may contain a table listing the courses by topic and their corresponding primary psychological traits. FIG. 2 illustrates such a database in the form of a table 200. In second from the left column, the different topics appear. Here, only three topics are shown ((1) Tailgating and Rear End Hits, (2) Lane and Space Violations, (3) Drowsy Driving), but many more topics may be available. For example, courses on the following topics may be available: Tailgating and Rear End Hits; Speeding—The Results; Traffic Control Devices and Intersections; Driver Impairment—Asphalt, Alcohol and Drugs; Lane and Space Violations; Driver Inattention and Distractions (Cell Phones, Texting and more); Stress, Choice and Driving Habits; Night Driving and Circadian Factors; Drowsy Driving; Driver Attitude and Behaviors; Special Equipment (Seatbelts, Airbags, Antilock Braking System, Stability Control Systems); Rental Vehicles; Hotel Security; The average ticket getter—Who gets tickets why and when?; Vehicle Inspection, Use and Maintenance; Know it, don't blow it—Emergency Actions; Avoiding Parking Lot Crashes; Drinking and Driving; The effect of drugs on driving—both legal and illegal; Keeping an escape route; Snow, Ice, Rain, Fog—Driving Facts; You and big vehicles—trucks, camper, trailer, etc.; 12 Techniques to reduce gas consumption; SMARTDRIVER highway travel; Reverse (Backing Up); Avoiding Animal Collisions; Collisions while changing lanes; Belts, bags and breaks; Vehicle systems, stability, traction control, antilock breaks and more; Pay attention distractions are deadly; Watch out for aggressive drivers; SMARTDRIVER business travel; Setting your mirrors to avoid blind spots; Statistical information that can save your life; The most important inches on your vehicle—tire surfaces; Vehicle operation—the differences (Car, SUV, Van, Truck, Trailer, Motor Home); and Telematics—Good and Bad.

In FIG. 2, three different courses are available under the topic Tailgating & Rear End Hits: TREH-1, TREH-2, and TREH-3. The TREH-1 course may be associated with the Dominance and Influence traits; in other words, TREH-1 would be selected for a participant with the primary psychological trait of Dominance or Influence when a course under the Tailgating topic is needed for the participant. Similarly, for a participant with the Steadiness primary psychological trait, the TREH-2 course would be selected, and for a participant with the Consciousness primary trait, the TREH-3 course would be selected. Under the topic Lane & Space Violations, the LSV-1 course would be selected for a participant with Dominance or Influence as the primary psychological trait, and the LSV-2 course would be selected for a participant with the Steadiness or Consciousness as the primary trait. Under the Drowsy Driving, the DD-1 course would be selected for a participant with the Dominance or Influence as the primary psychological trait, the DD-2 course would be selected for a participant with the Steadiness as the primary trait, and the DD-3 course would be selected for a participant with the Consciousness as the primary trait. The system may automatically select the appropriate course based on the primary trait.

Taking the Drowsy Driving topic, for example, the three courses (DD-1, DD-2, and DD-3) vary based on the psychological profile (the resulting behavioral trails) of the participant. Each course varies by the script content, length (time), and the number of video based examples. In the different course curriculum, the system may present just facts and/or facts and/or conclusions. Based on the Dominance and Influence behavioral traits, for example, the DD-1 course is developed to be straightforward and to the point, without the detail that is presented in DD-2 or DD-3.

The DD-2 course, in contrast, is presented in much more detail and the curriculum is based on the script with additional facts regarding and descriptions of drowsy driving. The script here may be twice as long as that which is presented for DD-1. The personality type with resulting behavioral trait of Steadiness will thus achieve a higher level of comprehension and retention based on a longer, more detailed presentation.

The DD-3 course may be similar to the DD-2 course, with yet additional detail.

As will he discussed below, each course also varies by the method of delivery of the course, including delivery of charts and charts with supporting information, and in the method of testing the participant to measure comprehension and retention of the material.

It should be noted that the number of topics and the specific topic selections can also be selected for a particular participant based at least in part on the psychological profile of the participant. For example, a participant with the Dominance trait, the Tailgating and Speeding topics might be selected, while the participants with Influence and Steadiness dominant traits might be assigned Hotel Security and Drinking and Driving topics. The selection/assignment of topics may be done in the manner analogous to that described above for selection of the courses within a particular topic, e.g., using a table of topic selections for each primary trait. Thus, selection of the curriculum may include the substeps of (1) selecting the topics and (2) selecting the courses for each of the selected topics. In embodiments, however, the selection of topics is not made based on the psychological profile; for example, the same topics may be selected regardless of the psychological profile, or the topic selection may be based on other factors; the courses for each of the topics are still selected based at least in part on the psychological profile.

Returning now to FIG. 1, in step 120 the psychological profile (supplemented with the additional information, if applicable) is again processed or analyzed to determine appropriate method(s) of delivery of the driver education curriculum. Note that various courses may be delivered differently. For example, some courses may be delivered as video feeds, others as audio presentations, still others can be delivered as textual presentations on a computer screen, which may be accompanied by audio. Combinations of all these delivery techniques may be used as well. In aspects, different methods of delivery may be selected for different courses of the same curriculum selected for the same participant. Moreover, portions of the same course may be delivered in different ways, depending on the psychological profile. The course materials may be interactive, and their presentation may be performed by a computer, via a network (e.g., within a client-server model), or from locally stored presentation data.

In step 125, the psychological profile (supplemented with the additional information, if applicable) is again processed or analyzed to determine appropriate method(s) of testing the participant for knowledge of the selected curriculum. Here, the testing may include, for example, multiple choice questions, questions calling for a calculation to be entered by the participant, questions calling for a narrative response. Based on the psychological profile, the testing may be timed or not timed. Timing may be limited for each individual question, for groups of related or unrelated questions, or for all of the questions as a single testing session.

In step 130, the selected curriculum is delivered using the selected method(s) of delivery.

In step 135, attendance or participation of the participant in the study of the curriculum is verified. Delivery and verification may and generally are performed concurrently, although this is not necessarily a requirement. A computer station may be used for delivery of the curriculum and for concurrent verification of attendance of the participant. For example, an applet may be spawned to create a pop-up window periodically on the computer used to deliver the curriculum, requiring the participant to perform some function, such as a simple click, providing personal information, or answering a question. The pop-up may appear periodically or randomly, and a record of waiting times elapsed between the pop-up's appearance and the participant's response may be stored and analyzed to determine whether the participant has actually completed each component of the driver training curriculum. For example, a period exceeding a predetermined length between the pop-up and the participant's required action may indicate that the participant should be denied credit for all or some portion of the curriculum. In addition to or instead of the above method, a camera built into the system (e.g., notebook computer camera) may record continually or continuously the appearance of the space in front of the computer during training, and the system may store and/or transmit the video or still recording for subsequent analysis and confirmation of attendance. The subsequent analysis and confirmation may be automated, for example, based on computer facial recognition. Furthermore, the system may ask the participant to make a voice response, and then process the voice response through a voice recognition module to verify presence of the participant by matching the voice response to the previously-acquired voice sample of the participant.

The system records the participant's successful completion of the driver training program for future reference.

In step 140, the participant's knowledge of the curriculum is tested, using the selected method(s) of testing. In the context of the Drowsy Driving courses discussed above, the test selected for the participants with the Dominance and Influence primary traits may include one self-correcting sample question, and ten short, precise questions, with True/False answer options. The test selected for the participants with the Steadiness primary trait may include two sample to self-correcting questions, and fifteen detailed True/False questions. The test selected for the participants with the Consciousness primary trait may include five sample, multiple choice self-correcting questions, and twenty detailed multiple choice questions.

Upon completion of the above steps, the process 100 terminates at a flow point 199. The process can, of course, be repeated as needed. In fact, if the testing indicates a need for additional or remedial training of the participant, a remedial curriculum may be selected for the participant based on the participant's psychological profile, the additional information (of step 110), and/or the testing results of the participant obtained in the step 140. The delivery method for the remedial curriculum, and the testing method upon completion of the remedial curriculum may also be selected based on the participant's psychological profile, the additional information (of step 110), and/or the testing results of the participant obtained in the step 140. In effect, the process 100 may be repeated with the additional information of step 110 now including the test, results from the step 140. In embodiments, the remedial training is performed so that a different course from each topic is presented to the participant. In other words, course repetition is avoided as long as the inventory of courses under a particular topic has more than a single course. A different set of tables such as the table 200 of FIG. 2 may be stored for the purpose of selecting the remedial curriculum.

It should be noted that delivery may be interleaved in time with testing. In other words, a portion of the selected curriculum (e.g., a single course or several courses) can be delivered to the participant, and the participant can then be tested for knowledge of the materials/topics of the courses; additional course or courses can be delivered next, again followed by corresponding testing, and so on. Analogously, the analyzing steps 115, 120, and 125 (or any two of them) may be combined, so that the psychological profile is processed/analyzed once to select the driver education curriculum, the method(s) of delivering the curriculum, and the methods of testing the participant. More generally, although the process steps and decisions are described serially, certain steps and decisions may be performed by separate elements in conjunction or in parallel, asynchronously or synchronously, in a pipelined manner, or otherwise. There is no particular requirement that the steps and decisions be performed in the same order in which this description lists them, except where a specific order is inherently required, explicitly indicated, or is otherwise made clear from the context. Furthermore, not every illustrated step and decision block may be required in every embodiment, while some steps and decision blocks that have not been specifically illustrated, may be desirable or necessary in some embodiments. It should be noted, however, that a particular embodiment uses the specific steps and decision blocks that appear in the Figure(s) in the particular order shown in the Figure(s).

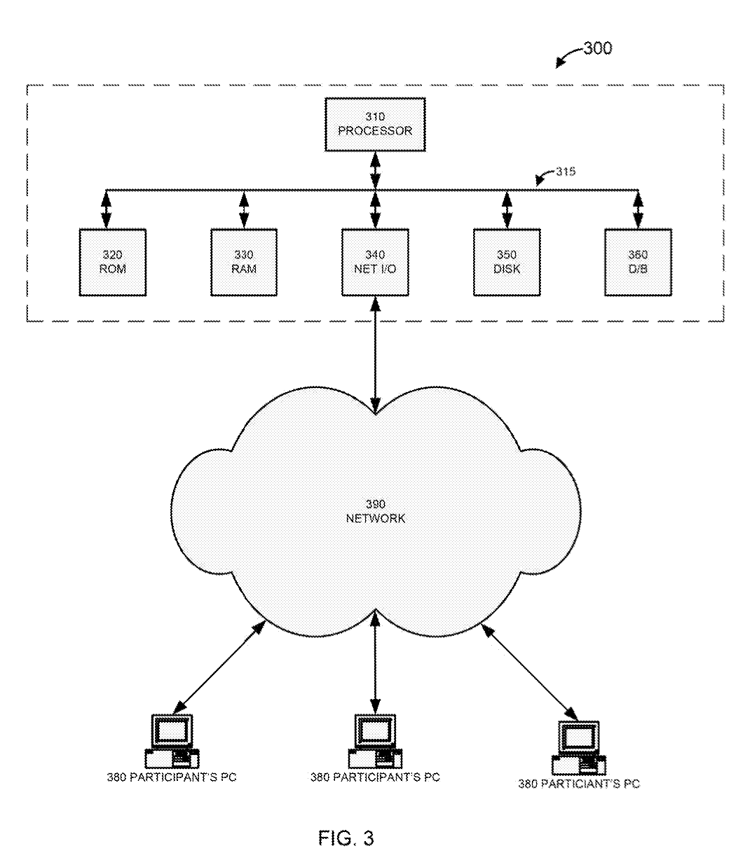

FIG. 3 illustrates in a simplified block diagram manner a computer-based system 300 configured in accordance with selected aspects described in this document. As shown in FIG. 3, the system 300 is coupled to a participants' computers 380 via a communication network 390. FIG. 3 does not show many hardware and software modules of the system 300, and omits several physical and logical connections. The system 300 can be implemented as a special purpose data processor, a general-purpose computer, a computer system, or a group of networked computers or computer systems configured to perform the steps of the driver education methods described in this document. In some embodiments, the system 300 is built on a personal computer platform, such as a Wintel PC or a Mac computer. The personal computer may be a desktop or a notebook computer.

The system 300 includes a processor 310, read only memory (ROM) module 320, random access memory (RAM) module 330, network interface 340, a mass storage device 350, and a database 360. These components are coupled together by a bus 315. In the illustrated embodiment, the processor 310 is a microprocessor, and the mass storage device 350 is a magnetic disk drive. The mass storage device 350 and each of the memory modules 320 and 330 are connected to the processor 310 to allow the processor 310 to write data into and read data from these storage and memory devices. The network interface 340 couples the processor 310 to the network 390, for example, the Internet. The nature of the network 390 and of the devices that may be interposed between the system 300 and the network 390 determine the kind of network interface 340 used in the system 300. In some embodiments, for example, the network interface 340 is an Ethernet interface that connects the system 300 to a local area network, which, in turn, connects to the Internet.

The database 360 is used for organizing and storing data that may be needed or desired in performing the method steps described in this document. The database 360 may be a physically separate system coupled to the processor 310, as illustrated in FIG. 3. In one alternative embodiment, the processor 310 and the mass storage device 350 are configured to perform the functions of the database 360.

The processor 310 reads and executes program code instructions stored in the ROM module 320. Under control of the program code, the processor 310 configures the system 300 to perform the steps of the methods described in this document. In addition to the ROM module 320, the program code instructions may be embodied in machine-readable storage media, such as hard drives, floppy diskettes, CD-ROMs, DVDs, flash memories, battery-backed memories, and similar devices. The program code can also be transmitted over a transmission medium, for example, over electrical wiring or cabling, through optical fiber, wirelessly, or by any other form of physical transmission. The transmission can take place over a dedicated link between telecommunication devices, or through a wide- or local-area network, such as the Internet, an intranet, extranet, or any other kind of public or private network. In one embodiment, the program code is downloaded to the system 300 through the network interface 340.

In embodiments, there is no need for a networked system. For example, a computer system such as a participant's computer 380 may perform all steps of a method according to selected aspects described herein.

This document describes the inventive processes and systems for providing driver training program in considerable detail. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

I claim:

1. A computer-implemented driver training program method for improving driving skills and behaviors of a participant, the method comprising steps of
obtaining by a computer a psychological profile of the participant;
analyzing by the computer the psychological profile of the participant to select from a plurality of driver education curricula a selected driver education curriculum for the participant; and
delivering the selected driver education curriculum to the participant.

2. The computer-implemented driver training program method of claim 1, wherein the step of obtaining comprises receiving by the computer the psychological profile of the participant.

3. The computer-implemented driver training program method of claim 1, wherein the step of obtaining comprises administering by the computer to the participant a psychological profiling test to obtain the psychological profile of the participant.

4. The computer-implemented driver training program method of claim 3, further comprising:
analyzing by the computer the psychological profile of the participant to select from a plurality of delivery methods a selected delivery method for delivery to the participant of the driver education curriculum;
wherein the step of delivering is performed using the selected delivery method.

5. The computer-implemented driver training program method of claim 4, further comprising:
analyzing by the computer the psychological profile of the participant to select from a plurality of testing methods a selected testing method for testing comprehension and retention by the participant of material of the selected curriculum; and
testing by the computer the comprehension and retention by the participant of the material of the selected curriculum using the selected testing method.

6. The computer-implemented driver training program method of claim 5, wherein the step of administering is performed so that the psychological profile is a Dominance/Influence/Steadiness/Consciousness (DISC) profile.

7. The computer-implemented driver training program method of claim 5, wherein the step of administering is performed so that the psychological profile is a COLORS profile.

8. The computer-implemented driver training program method of claim 5, wherein the step of administering is performed so that the psychological profile is a Wilson Learning Systems profile.

9. The computer-implemented driver training program method of claim 5, wherein the step of administering is performed so that the psychological profile is a Myers-Briggs Type Indicator profile.

10. The computer-implemented driver training program method of claim 5, wherein the step of delivering is performed by the computer through a network.

11. The computer-implemented driver training program method of claim 5, wherein the step of delivering is performed by the computer directly.

12. The computer-implemented driver training program method of claim 5, wherein the step of analyzing by the computer the psychological profile of the participant to select from the plurality of driver education curricula comprises:
analyzing the psychological profile to select from a plurality of driver education topics one or more selected driver education topics; and
for each driver education topic from the one or more selected driver education topics, analyzing the psychological profile to select from a plurality of courses associated with said each driver education topic a selected course.

13. The computer-implemented driver training program method of claim 5, wherein the psychological profile comprises a primary psychological trait, and wherein the step of analyzing by the computer the psychological profile of the participant to select from the plurality of driver education curricula comprises:
analyzing the psychological profile to select from a plurality of driver education topics one or more selected driver education topics; and
for each driver education topic from the one or more selected driver education topics, determining from a plurality of courses associated with said each driver education topic a selected course, wherein the selected course corresponds uniquely to the selected driver education topic and to the primary psychological trait.

14. The computer-implemented driver training program method of claim 5, wherein the psychological profile comprises a primary psychological trait, and wherein the step of analyzing by the computer the psychological profile of the participant to select from the plurality of driver education curricula comprises:
selecting from a table a course corresponding to the primary psychological trait.

15. The computer-implemented driver training program method of claim 5, further comprising:
supplementing the psychological profile with additional information before the steps of (1) analyzing by the computer the psychological profile of the participant to select from the plurality of driver education curricula, (2) analyzing by the computer the psychological profile of the participant to select from the plurality of delivery methods, and (3) analyzing by the computer the psychological profile of the participant to select from the plurality of testing methods.

16. The computer-implemented driver training program method of claim 15, further comprising:
performing by the computer hazard recognition testing of the participant to obtain hazard recognition test results;
wherein:
the step of administering is performed so that the psychological profile is selected from a group consisting of Dominance/Influence/Steadiness/Consciousness (DISC) profile, a COLORS profile, a Wilson Learning Systems profile, and a Myers-Briggs Type Indicator profile; and
the additional information comprises the hazard recognition test results, and the step of analyzing by the computer the psychological profile of the participant to select from the plurality of driver education curricula is based at least in part on the hazard recognition test results.

17. The computer-implemented driver training program method of claim 16, wherein the psychological profile comprises a primary psychological trait, and wherein the step of analyzing by the computer the psychological profile of the participant to select from the plurality of driver education curricula comprises:
selecting from a plurality of driver education topics one or more selected driver education topics based on the hazard recognition test results; and
for each driver education topic from the one or more selected driver education topics, determining from a plurality of courses associated with said each driver education topic a selected course, wherein the selected course corresponds to the primary psychological trait and to said each driver education topic.

18. The computer-implemented driver training program method of claim 15, further comprising:
obtaining by the computer real-life driving data of the participant;
wherein the step of administering is performed so that
the psychological profile is based in part on the real-life driving data of the participant; and
the psychological profile is selected from a group consisting of Dominance/Influence/Steadiness/Consciousness (DISC) profile, a COLORS profile, a Wilson Learning Systems profile, and a Myers-Briggs Type Indicator profile.

19. A computer system comprising a processor configured to cause the computer system to perform a driver training program method for improving driving skills and behaviors of a participant, the method comprising steps of:
obtaining by the computer system a psychological profile of the participant;
analyzing by the computer system the psychological profile of the participant to select from a plurality of driver education curricula a selected driver education curriculum for the participant; and
delivering by the computer system the selected driver education curriculum to the participant.

20. An article of manufacture comprising a machine-readable memory storing instructions, wherein, when the instructions are executed by a processor of a computer system, the instructions configure the processor to cause the computer system to perform a driver training program method for improving driving skills and behaviors of a participant, the method comprising steps of:
obtaining by the computer system a psychological profile of the participant;
analyzing by the computer system the psychological profile of the participant to select from a plurality of driver education curricula a selected driver education curriculum for the participant; and
delivering by the computer system the selected driver education curriculum to the participant.
